(19) United States
(12) Patent Application Publication
(10) Pub. No.: US 2012/0130860 A1
(43) Pub. Date: May 24, 2012

(54) REPUTATION SCORING FOR ONLINE STOREFRONTS

(75) Inventors: Clifford Akihiko Suzuki, Redmond, WA (US); Aayaz Bhorania, Redmond, WA (US); Rajesh Selvamani, Woodinville, WA (US); Daniel Schonberg, Seattle, WA (US); Chi-Ming Lin, Sammamish, WA (US); Jeffrey Johnson, Redmond, WA (US); John Mullally, Redmond, WA (US)

(73) Assignee: MICROSOFT CORPORATION, Redmond, WA (US)

(21) Appl. No.: 12/950,962

(22) Filed: Nov. 19, 2010

(51) Int. Cl. G06Q 30/00

(52) U.S. Cl. 705/27.1; 705/347

(57) ABSTRACT

Systems and techniques to provide an improved reputation scoring for products in an online storefront are described. A technique may include obtaining at least one objective measure and at least one subjective measure about a product in an online storefront; calculating a reputation level for the product from the subjective and objective measures; and displaying a listing for the product in the online storefront according to the reputation level. A technique may further include providing feedback to product developers about the reputation level of the product. Other embodiments are described and claimed.

### BACKGROUND

Stores with virtual or online storefronts may provide a rating system that allows purchasers to rate the products for sale. User ratings are, by their nature, subjective and may not accurately depict the quality of the product. Potential customers may not be able to distinguish true ratings from biased ratings. Product developers may not have an accurate idea of the success of their products in the marketplace and may have little incentive to improve the quality of the products.

It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to improve reputation scoring for online storefronts. Some embodiments are particularly directed to techniques to improve reputation scoring for online storefronts that improve product rating accuracy and incentivize better product quality. In one embodiment, for example, a technique may comprise obtaining at least one objective measure and at least one subjective measure about a product in an online storefront; calculating a reputation level for the product from the subjective and objective measures; and displaying a listing for the product in the online storefront according to the reputation level. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a first system for reputation scoring in an online storefront.

FIG. 2 illustrates an embodiment of objective measures.

FIG. 3 illustrates an embodiment of subjective measures.

FIG. 4 illustrates an embodiment of a reputation engine and online storefront.

FIG. 5 illustrates an embodiment of a logic flow.

FIG. 6 illustrates an embodiment of a computing architecture.

FIG. 7 illustrates an embodiment of a communications architecture.

### DETAILED DESCRIPTION

Various embodiments are directed to generating a more reliable and accurate measure of product quality in an online storefront. Embodiments may include both subjective and objective measures of product quality in calculating a reputation level for the product. The reputation level may be used to affect product visibility in the online storefront. Reputation level may also be provided as feedback to product developers so that the developers may attempt to improve their products.

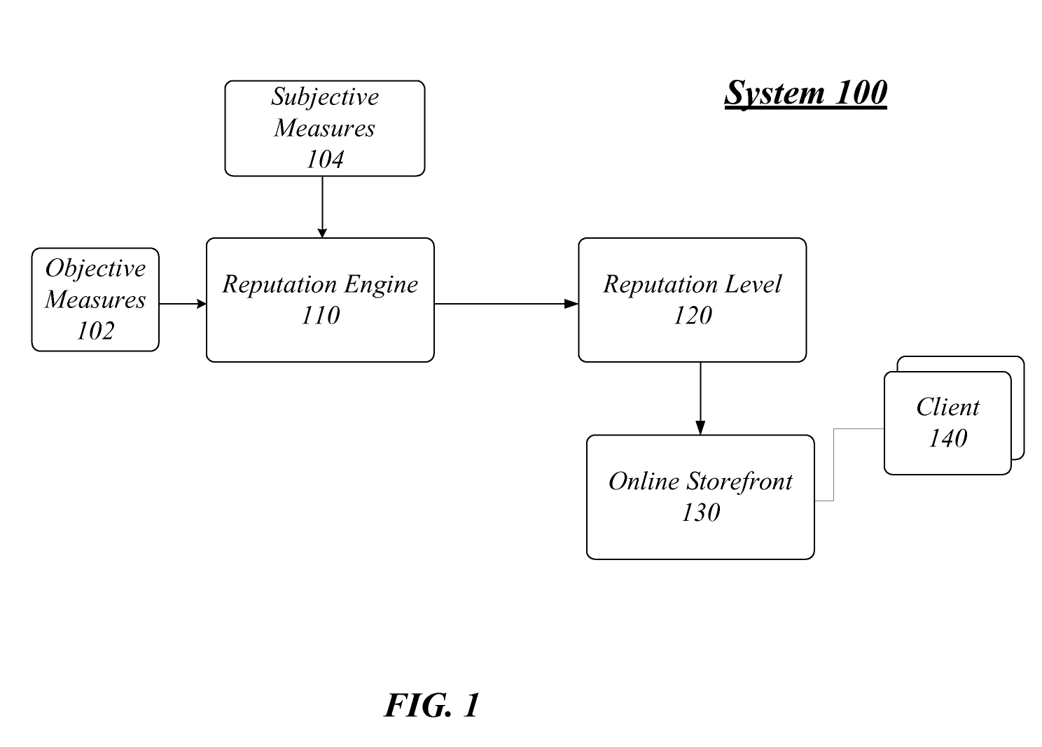

FIG. 1 illustrates a block diagram for a system 100 to generate a product reputation level. In one embodiment, for example, the system 100 may comprise a computer-implemented system 100 having multiple components, such as a reputation engine 110, and an online storefront 130. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 110, 130 may be communicatively coupled via various types of communications media. The components 110, 130 may coordinate operations between each other. The coordination may involve the uni-directional or bi-directional exchange of information. For instance, the components 110, 130 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The components 110, 130 may be resident on one computing device, such as a server, or may be separated while in communication with each other. The computing device may include a logic device and a data store on a computer-readable storage medium. The data store may include, for example, data used in calculating various objective and/or subjective measures of the products offered in the online storefront.

In various embodiments, the system 100 may comprise reputation engine 110. Reputation engine 110 may receive objective measures 102 and subjective measures 104 about products offered in online storefront 130. In an embodiment, reputation engine 110 may calculate some or all of the objective measures 102 and subjective measures 104. Reputation engine 110 may calculate a reputation level 120 for some or all of the products. Reputation level 120 may be a numeric score assigned to a product. Reputation level 120 may range, for example, between 0 and 1, −1 to 1, 1 to 10, etc.

In various embodiments, the system 100 may comprise online storefront 130. Online storefront 130 may offer one or more products for sale or download, for example, via a web browser operating on client(s) 140. The products offered may include, for example, software applications, hardware devices, music files, video files, or other products. Online storefront 130 may use reputation level 120 to affect how products are displayed. For example, products with a higher reputation level may be displayed more prominently than products with a lower reputation level. Higher level products may, for example, appear first in a “browse” mode, or higher in a list of search results.

Online storefront 130 may provide an interface for users to provide feedback about products obtained from the online storefront. Online storefront 130 may provide user feedback and sales data to reputation engine for use in calculating reputation level 120.

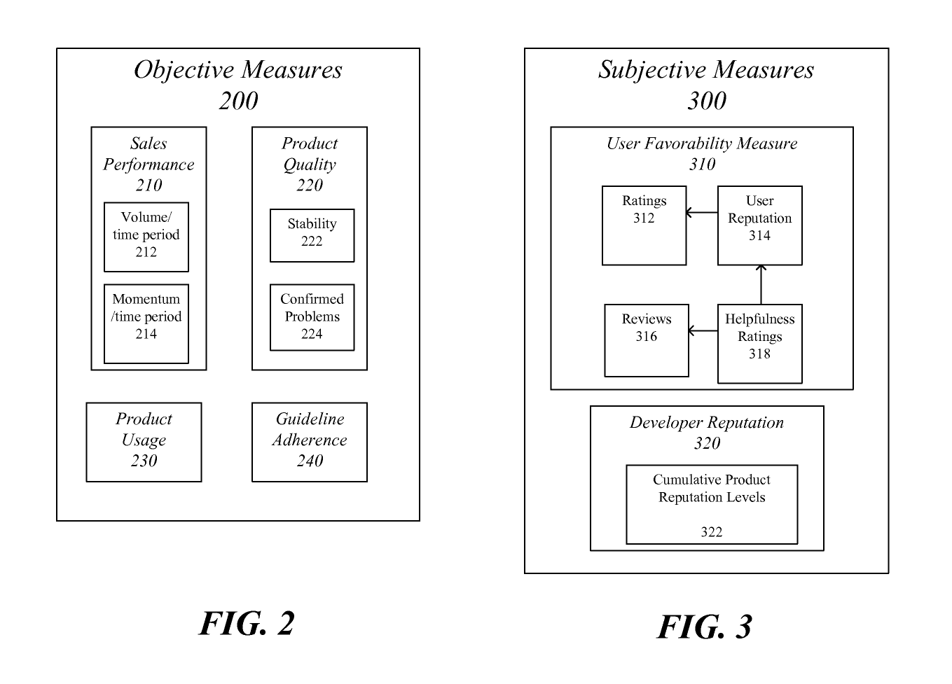

FIG. 2 illustrates an example of objective measures 200 that may be used to calculate reputation level 130. Objective measures 200 may include, for example, sales performance 210, product quality 220, product usage 230 and/or guideline adherence 240.

Sales performance 210 may include sales volume 212 over a period of time of a product, for example, number of units sold over the past 30 days. A larger sales volume may positively affect reputation level compared to smaller sales volumes of other products. Sales performance 210 may include sales momentum 214 over a period of time. Sales momentum 214 may refer to an increase (or decrease) in number of units sold over time. A positive momentum may positively affect reputation level. Other objective means of measuring sales performance may also be used. The embodiments are not limited to these examples.

Product quality 220 may include a stability measure 222. In particular, if the product is software, stability 222 may refer to how often the software “crashes” or otherwise fails. Better product stability may positively affect reputation level. Other objective means of determining product quality may also be used. Device quality may be measured, for example, by how many returns there are for the device, or how many in-warranty repairs it has. The embodiments are not limited to these examples.

Product usage 230 may measure how often a product is used once purchased. Examples of product usage 230 may include a number of times used in a time period; consistency of use, e.g. twice a week; or number of minutes used in a time period. A product that is purchased and then used only once, for example, would receive a low usage score, negatively affecting reputation level.

Guideline adherence 240 may measure how well a product adheres to guidelines for products specified by the online storefront. Examples may include, for software, optimization for a hardware requirement, memory use, etc. The guidelines may be a set of criteria that must be met in order to offer the product in the online storefront. Alternatively, a minimum number of a set of guidelines may be required to be met. In an embodiment, there may be no requirement to meet the guidelines, but a product that meets more of the guidelines than another product may obtain a higher guideline adherence 240 score.

FIG. 3 illustrates an example of subjective measures 300 that may be used to calculate reputation level 130. Subjective measures 300 may include, for example, a user favorability measure 310, and/or developer reputation 320. The embodiments are not limited in this context.

User favorability measure 310 may combine user ratings 312 with user reviews 316 to obtain a favorability score. Combining may include, for example, addition, averaging, weighted averaging, or some other operation.

Ratings 312 may be adjusted according to user reputation 314. This adjustment may help to minimize the effect of erroneous ratings, for example, artificially high ratings from users that are employed by the developer of the product. User reputation 314 may be calculated from a variety of factors, including but not limited to: the amount of participation of a user, the quality of the participation, the number of confirmed problems reported by the user about product, and/or the number of confirmed problems reported about the user. Participation may refer to, for example, the number of products rated or reviewed, and/or number of problems reported. Quality may refer to a helpfulness rating 318 applied to ratings or reviews, e.g. input from other users about how influential a rating or review was to them. Reputation engine 120 may calculate a user reputation score for each user, which may be stored by system 100.

Reviews 316 may be adjusted by helpfulness rating 318 prior to combining reviews 316 with ratings 312 to produce user favorability measure 310.

Developer reputation 320 may include the cumulative product reputation levels 322 for some or all products offered by a particular developer. Initially, a developer will have no reputation 320. Once a second product is offered however, a reputation may be established. Newer products may be weighted more heavily than older applications in the reputation measure. Developer reputation 320 may reward consistently “good” and/or improving developers by positively affecting the reputation level for the developers' individual products.

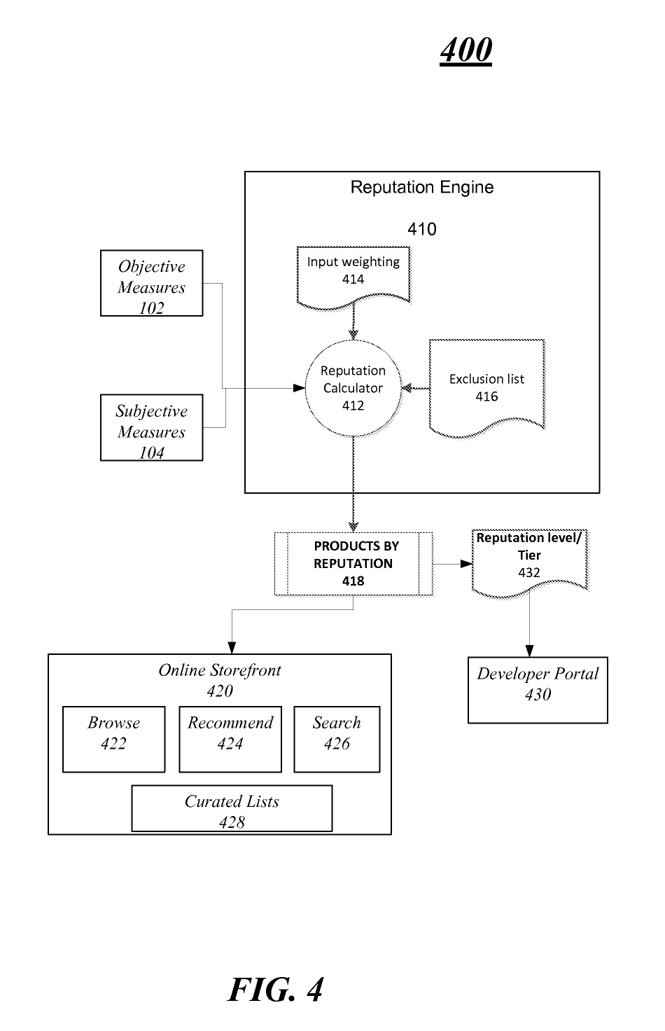

FIG. 4 illustrates a block diagram 400 of a reputation engine 410 and an online storefront 420. Reputation engine 410 may be an example of reputation engine 110, and online storefront 420 may be an example of online storefront 130.

Reputation engine 410 may receive objective measures 102 and subjective measures 104 at reputation calculator 412. Reputation calculator 412 may calculate a reputation level for a product by weighting the measures according to configurable input weighting 414. The configurable input weighting 414 may cause some measures to influence the reputation level more than other measures. If a weighting scheme does not yield acceptable results, the weights may be reconfigured as needed. Some products may be excluded from reputation scoring, and may be assigned a very high or highest rating. Such excluded products may be listed in exclusion list 416, which may be used by reputation calculator 412 to skip calculating reputation level for an excluded product. Reputation calculator 412 may operate on a periodic schedule, for example, once a day, twice a day or whenever one of the measures is updated.

Reputation calculator 412 may output a set of products sorted by reputation 418. The set 418 may include, for each product in the set, the reputation level of the product, a comparative rank of the product, a percentile of reputation level, and/or a tier. Products may be sorted into two or more tiers based on their reputation level or percentile, for example, a gold tier, a silver tier, and a bronze tier. In an embodiment, products with a sufficiently low reputation level may be removed from the set 418 and the online storefront altogether.

The set 418 may be used by online storefront 420. In a browse 422 function, for example, online storefront 422 may display the highest ranked products by reputation level, while allowing the user to browse or navigate to successively lower ranked products. In a recommend 424 function, online storefront 420 may provide lists of products that are recommended, for example, for specific purposes, and show the highest ranked products in a category first. In an embodiment, the lowest ranked products may be automatically excluded from appearing in such a list. In a search function 426, online storefront 420 may allow the user to search for products that meet one or more search criteria, and may list the highest ranked products meeting the search as the most relevant results. Online storefront 420 may also provide curated lists 428, which may be lists of products assembled by one or more storefront personnel or by a favored developer or original equipment manufacturer (OEM). In an embodiment, only products in the top percentile or tier may be permitted to appear in a curated list.

Reputation level and/or tier information 432 may be extracted from set 418 and provided via a developer portal 430 to the developer of a product. Such feedback may show the developer that something about their product needs to be improved.

Generally, higher reputation level may translate to more or better revenue opportunities for a product in the online storefront. Reputation levels that consider some objective measures may be less prone to inaccuracies or biases present in conventional ratings systems. Accurate feedback may incentivize developers to improve their products and thus their revenue.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

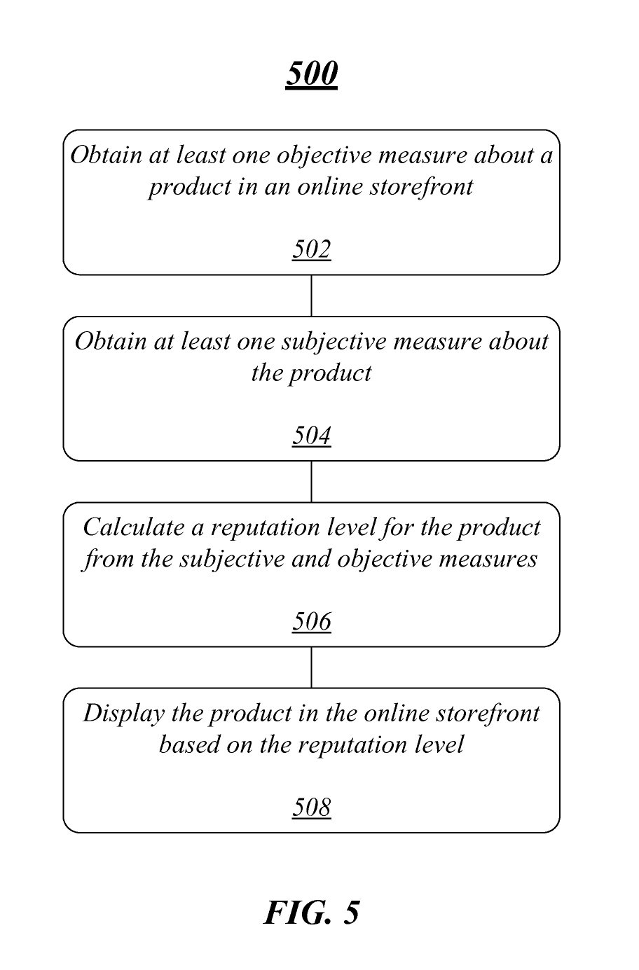

FIG. 5 illustrates one embodiment of a logic flow 500. The logic flow 500 may be representative of some or all of the operations executed by one or more embodiments described herein.

In the illustrated embodiment shown in FIG. 5, the logic flow 500 may obtain at least one objective measure about a product offered in an online storefront at block 502. For example, objective measures may include a sales performance of the product, a product quality measure, a measure of use of the product after purchase, and a measure of how the product adheres to guidelines. The objective measures may be provided to the reputation engine by the online storefront or data stores in communication with the reputation engine.

The logic flow 500 may obtain at least one subjective measure about the product at block 504. For example, subjective measures may include a product developer reputation and a user favorability measure. These measures may be calculated by the reputation engine, or may be determined separately and provided to the reputation engine.

The logic flow 500 may calculate a reputation level for the product at block 506. For example, the reputation engine may calculate a weighted average of the objective and subjective measures to obtain a numeric reputation level for a product. The weights assigned to the various measures may be determined by a configurable input weighting parameter. Other calculation methods may be used to determine a reputation level from the objective and subjective measures.

The logic flow 500 may display the product in the online storefront according to the product's reputation level at block 508. Products with a higher reputation level may be displayed more prominently than products with a lower reputation level. For example, a higher level product may appear at or near the top of a list of products or on the first page of multiple pages of products listings. A higher level product may be displayed as more relevant than a lower level product in a search result. Higher level products may appear on lists of recommended products, while lower level products may be excluded. Other methods of increasing display prominence may also be used, such as large fonts, larger images, other visual mechanisms to attract attention, etc.

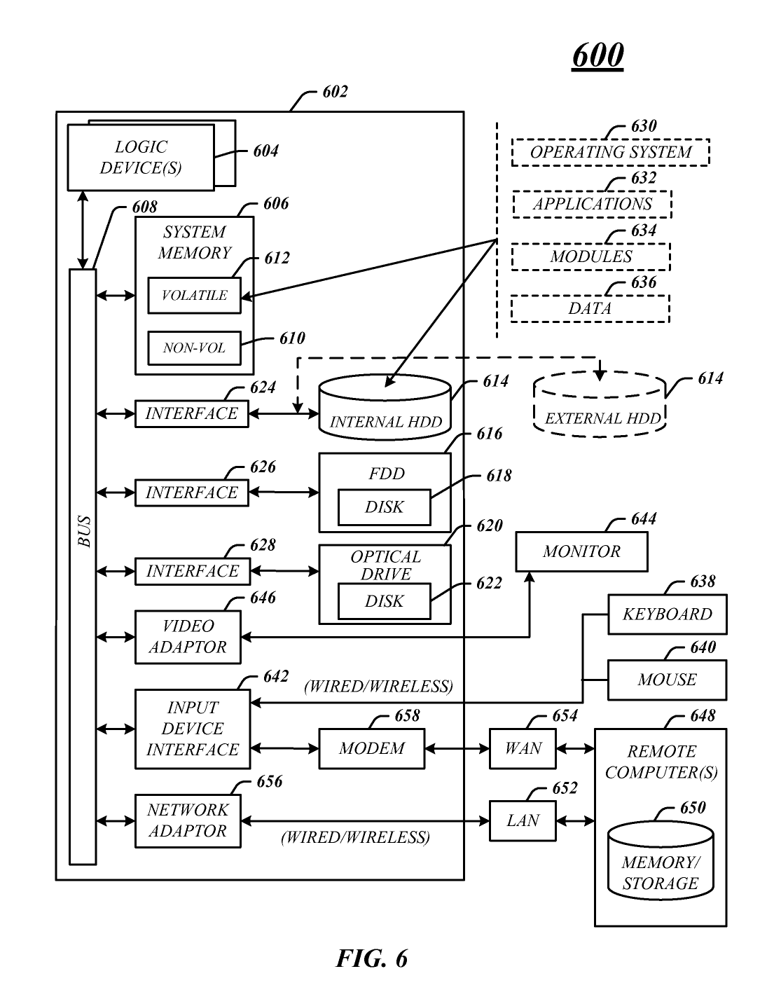

FIG. 6 illustrates an embodiment of an exemplary computing architecture 600 suitable for implementing various embodiments as previously described. The computing architecture 600 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 600.

As shown in FIG. 6, the computing architecture 600 comprises one or more logic devices 604, a system memory 606 and a system bus 608. Examples of a logic device may include, without limitation, a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s) 604. The system bus 608 provides an interface for system components including, but not limited to, the system memory 606 to the logic device(s) 604. The system bus 608 can be any of several types of bus structure that may further interconnect to a memory bus (with or without a memory controller), a peripheral bus, and a local bus using any of a variety of commercially available bus architectures.

The system memory 606 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media, including an internal hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. The one or more application programs 632, other program modules 634, and program data 636 can include, for example, the reputation engine 110 and/or online storefront 130.

A user can enter commands and information into the computer 602 through one or more wire/wireless input devices, for example, a keyboard 638 and a pointing device, such as a mouse 640. Other input devices may include a microphone, an infra-red (IR) remote control, a joystick, a game pad, a stylus pen, touch screen, or the like. These and other input devices are often connected to the logic device(s) 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

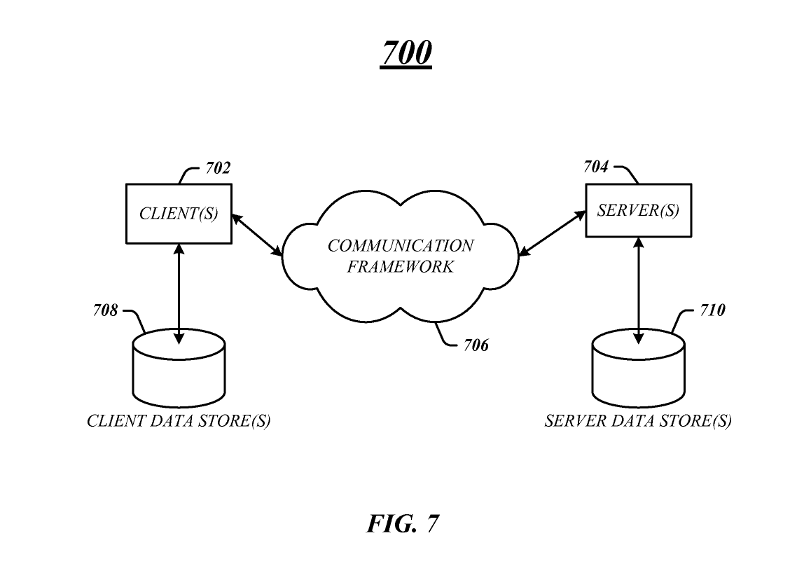

FIG. 7 illustrates a block diagram of an exemplary communications architecture 700 suitable for implementing various embodiments as previously described. The communications architecture 700 includes various common communications elements, such as a transmitter, receiver, transceiver, radio, network interface, baseband processor, antenna, amplifiers, filters, and so forth. The embodiments, however, are not limited to implementation by the communications architecture 700.

As shown in FIG. 7, the communications architecture 700 comprises includes one or more clients 702 and servers 704. The clients 702 may implement the clients 140. The servers 704 may implement the online storefront 130. The clients 702 and the servers 704 are operatively connected to one or more respective client data stores 708 and server data stores 710 that can be employed to store information local to the respective clients 702 and servers 704, such as cookies and/or associated contextual information.

The clients 702 and the servers 704 may communicate information between each other using a communication framework 706. The communications framework 706 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 702 and the servers 704 may include various types of standard communication elements designed to be interoperable with the communications framework 706, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 702 and a server 704 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
obtaining at least one objective measure about a product in an online storefront;
obtaining at least one subjective measure about the product;
calculating a reputation level for the product from the at least one subjective and the at least one objective measures; and
displaying a listing for the product in the online storefront according to the reputation level.

2. The method of claim 1, wherein calculating the reputation level comprises calculating a weighted average of the at least one subjective and the at least one objective measures.

3. The method of claim 1, wherein obtaining at least one objective measure comprises obtaining at least one of: a sales performance of the product, a product quality measure, a measure of use of the product after purchase, and a measure of how the product adheres to guidelines.

4. The method of claim 3, wherein a sales performance comprises at least one of:
sales volume and sales momentum.

5. The method of claim 3 wherein the product is a software application and wherein the product quality measure comprises at least one of a stability measure, a performance measure and a number of confirmed problems.

6. The method of claim 1, wherein obtaining at least one subjective measure comprises obtaining at least one of: a product developer reputation and a user favorability measure.

7. The method of claim 6, wherein obtaining the user favorability measure comprises:
obtaining a user rating of the product;
obtaining a reputation measure of the user reviewer; and
adjusting the user rating with the reputation measure to obtain the user favorability measure.

8. The method of claim 1, further comprising:
sorting the products in the online storefront by reputation level; and
assigning a product to a tier according to the percentile of the reputation level of the product.

9. The method of claim 8, further comprising:
providing at least one of the reputation level, the percentile, and the tier to the developer of the product.

10. An article comprising a computer-readable storage medium containing instructions that when executed cause a system to:
calculate a reputation level for a product offered in an online storefront from at least one subjective measure and at least one objective measure; and
display a listing for the product in the online storefront according to the reputation level.

11. The article of claim 10, wherein the at least one objective measure comprises at least one of: a sales performance of the product, a product quality measure, a measure of use of the product after purchase, and a measure of how the product adheres to guidelines.

12. The article of claim 10, wherein the at least one subjective measure comprises at least one of: a product developer reputation and a user favorability measure.

13. The article of claim 10, further comprising instructions that when executed cause the system to:
calculate the at least one subjective measure.

14. The article of claim 10, wherein the instructions to display the product comprise instructions to:
sort the products in the online storefront by reputation level; and
display products with higher reputation level more prominently than products with a lower reputation level.

15. The article of claim 10, wherein the instructions to display products with higher reputation level more prominently comprise instructions to at least one of:
display the products higher in a list of products;
display the products in a first page displaying products;
display the products in a recommended products list; and
display the products as having more relevance in a search results display.

16. An apparatus, comprising:
a logic device;
a data store to store data, the data comprising subjective measures and objective measures about products offered in an online storefront; and
a reputation engine executing on the logic device to calculate a reputation level for a product from at least one subjective measure and at least one objective measure.

17. The apparatus of claim 16, further comprising:
the online storefront executing on the logic device to receive the reputation level, to display products according to the reputation levels, and to provide product sale information as an objective measure to the reputation engine.

18. The apparatus of claim 16, the reputation engine further to compute the at least one subjective measure.

19. The apparatus of claim 16, wherein the at least one objective measure comprises at least one of: a sales performance of the product, a product quality measure, a measure of use of the product after purchase, and a measure of how the product adheres to guidelines.

20. The apparatus of claim 16, wherein the at least one subjective measure comprises at least one of: a product developer reputation and a user favorability measure.
